(19) United States
(12) Patent Application Publication
(10) Pub. No.: US 2015/0098032 A1
(43) Pub. Date: Apr. 9, 2015

(54) PHASE CHANGE MATERIAL DISPLAY DEVICE

(71) Applicant: Samsung Display Co., Ltd., Yongin-City (KR)

(72) Inventor: Hye-Young PARK, Yongin-City (KR)

(73) Assignee: Samsung Display Co., Ltd., Yongin-City (KR)

(21) Appl. No.: 14/207,101

(22) Filed: Mar. 12, 2014

(30) Foreign Application Priority Data
Oct. 4, 2013 (KR) 10-2013-0118617

(51) Int. Cl. G02F 1/13

(52) U.S. Cl. CPC G02F 1/132
USPC 349/21

(57) ABSTRACT

A phase change material display device includes a first substrates a first electrode, a heat generation layer, a phase change material layer and a second electrode. The first electrode is disposed on the first substrate. The heat generation layer is on the first electrode. The phase change material layer is on the heat generation layer, and is configured with a phase change material of which optical characteristic is changed depending on temperature. The second electrode is disposed on the phase change material layer.

### RELATED APPLICATIONS

This application claims priority to and the benefit of Korean Patent Application No. 10-2013-0118617, filed on Oct. 4, 2013, in the Korean Intellectual Property Office, the entire contents of which are incorporated herein by reference in their entirety.

### BACKGROUND

1. Field

An aspect of the present application relates to a phase change material display device.

2. Description of the Related Art

A liquid crystal display (LCD) as one of flat panel display devices has a structure in which an array substrate having thin film transistors arranged thereon and a substrate having color filters formed thereon are sealed by injecting liquid crystals between the substrates. In the LCD, white light incident onto the LCD by a backlight unit passes through blue, red and green color filters via the liquid crystals, thereby forming an image.

However, the LCD uses the physical arrangement of the liquid crystals by controlling an electric field in the control of the light incident onto the LCD by the backlight unit. Therefore, the structure of the LCD is complicated, and the response speed of the LCD is low.

A phase change material (PCM) is a material used is a phase-change RAM (PRAM) which has recently come into the spotlight as one of next-generation nonvolatile memory technologies. The PRAM has a simple structure in which the PCM is controlled. In addition, the power consumption of the PRAM is low, and the response speed of the PRAM is fast.

The PCM has a characteristic which shows an optical and electrical switching phenomenon between amorphous and crystalline states. The PRAM has been developed as an information recording/storing medium using the electrical characteristic of the PCM, and studies have conducted to apply the PRAM to a display device, using the optical characteristic of the PCM.

### SUMMARY

According to an aspect of one embodiment there is provided a phase change material display device, including a first substrate, a first electrode disposed on the first substrate, a heat generation layer on the first electrode, and a phase change material layer on the heat generation layer. The phase change material layer is configured with a phase change material of which optical characteristic is changed depending on temperature. A second electrode is disposed on the phase change material layer.

The phase change material may be a chalcogenide based material.

The phase change material may include germanium (Ge)-antimony (Sb)-tellurium (Te).

The phase change material layer and the heat generation layer may be doped with at least one of carbon, nitrogen and oxygen.

The phase change material display device may further include a second substrate disposed on the second electrode.

The phase change material display device may further include a color filter layer disposed between the second electrode and the second substrate.

The phase change material display device may further include a backlight unit disposed beneath the first substrate configured to radiate light.

The phase change material display device may further include a reflective layer disposed beneath the first substrate configured to reflect light.

The phase change material display device may further include a color filter layer disposed between fee first substrate and the first electrode.

The phase change material display device may further include a light shielding layer between the first substrate and the first electrode.

The phase change material layer may have a crystalline state of the phase change material, changed depending on the temperature, and the light transmittance and reflexibility of the phase change material layer may be changed depending on the crystalline state.

A plurality of data lines, a plurality of scan lines intersecting the plurality of data lines, and a plurality of switching elements electrically coupled to the data lines and the scan lines may be on the first substrate.

The first electrode may be electrically coupled to one electrode of the switching element.

An insulating layer may be on the first substrate having the switching element thereon.

The first electrode, the heat generation layer and the phase change material layer may be separated by a light shielding pattern for defining unit pixels.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a plan view showing a unit pixel of a phase change material display device according to an embodiment.

FIG. 2 is a schematic sectional view of the phase change material display device, taken along line I-I′ of FIG 1.

FIGS. 3A, 3B and 3C are views illustrating changes in optical characteristics of a phase change material.

FIGS. 4, 5 and 6 are sectional views of phase change material display devices according to modified embodiments.

### DETAILED DESCRIPTION

Hereinafter, certain exemplary embodiments will be described with reference to the accompanying drawings. Here, when a first element is described as being coupled to a second element, the first element may be not only directly coupled to the second element but may also be indirectly coupled to the second element via a third element. Further, some of the elements that are not essential to the complete understanding of the embodiments are omitted for clarity. Also, like reference numerals refer to like elements throughout.

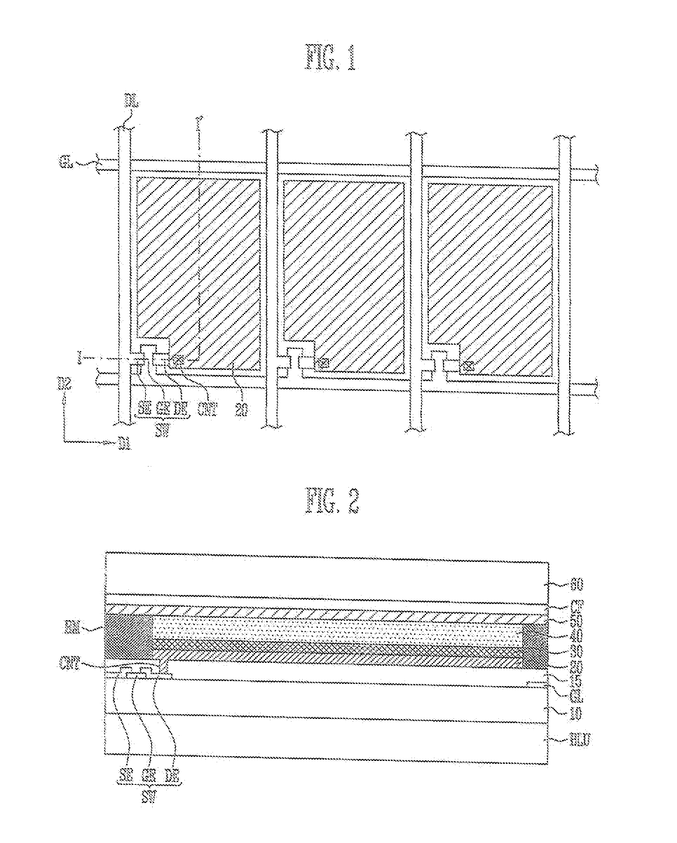

FIG. 1 is a plan view showing a unit pixel of a phase change material display device according to an embodiment. FIG. 2 is a schematic sectional view of the phase change material display device, taken along line I-I′ of FIG. 1.

For convenience, the unit pixel has been enlarged and illustrated in FIGS. 1 and 2. However, in the phase change material display device, the structure shown in FIGS. 1 and 2 is repetitively disposed on a substrate.

Referring to FIGS. 1 and 2, the phase change material display device includes a first substrate 10, a first electrode 20, a heat generation layer 30, a phase change material layer 40 and a second electrode 50. The phase change material display device may further include a backlight unit (BLU), an insulating layer 15, a light shielding pattern BM, a color filter layer CF and a second substrate 60.

The first substrate 10 may be made of a transparent material through which light can be transmitted. For example, the first substrate 10 may be made of at least one selected from the group consisting of triacetylcellolose (TAC), polycarbonate (PC), polyethersulfone (PES), polyethyleneterephthalate (PET), polyethylenenaphthalate (PEN), polyvinyl alcohol (PVA), polymethylmethacrylate (PMMA) and cyclo-olefin polymer (COP).

The backlight unit BLU may be positioned beneath the first substrate 10. The backlight unit BLU may be configured together with a light guide plate (not shown) for emitting light, using a cold cathode fluorescence tamp (CCFL) or light emitting diode (LED) as a light source. However, the present embodiment is not limited thereto, and any device may be used regardless of its kind as long as it is a device capable of emitting visible light, such as a flat panel lamp using plasma discharge.

A plurality of scan lines GL, a plurality of data fines DL and a plurality of switching elements SW are formed on the substrate 10. Here, the plurality of scan lines GL are extended in a first direction D1. The plurality of data lines DL intersect the scan lines GL while being insulated from the scan lines GL, and are extended in a second direction D2. The plurality of switching elements SW are electrically coupled to the scan lines GL and the data lines DL. The unit pixels are defined at intersection areas of the scan lines GL and the data lines DL.

The scan lines GL and the data lines DL may be made of aluminum (Al) based metal such as Al or Al alloy, silver (Ag) based metal such as Ag or Ag alloy, copper (Cu) based metal such as Cu or Cu alloy, molybdenum (Mo) based metal such as Mo or Mo alloy, chrome (Cr), tantalum (Ta) or titanium (Ti).

In an embodiment, the scan lines GL and the data lines DL may have a multi-layered structure including two conductive layers (not shown) having different physical properties. One of the two conductive layers may be made of metal having low resistivity, e.g., Al based metal, Ag based metal, Cu based metal or the like in order to reduce a signal delay or voltage drop. The other conductive layer may be made of another material particularly a material having excellent physical chemical and electrical contact characteristics with indium tin oxide (ITO) and indium zinc oxide (IZO). In other words, the other conductive layer may be made of Mo based metal, Cr, Ta, Ti or the like.

The switching elements SW are respectively electrically coupled to the scan lines GL and the data lines DL. The switching element SW supplies am electrical signal to the first electrode 20, and may be a thin film Transistor (TFT) turned on in response to a scan signal. Specifically, the switching element SW may include a gate electrode GE, a channel layer (not shown) disposed on the gate electrode GE, and source and drain electrodes SE and DE disposed on the channel layer.

For example, the gate electrode GE of the switching element SW is coupled to the scan line GL, the source electrode SE of the switching element SW is coupled to the data line BU and the drain electrode DE of the switching element SW is formed in a pattern separated from the source electrode SE.

As such, the switching elements SW each including the gate electrode GE, the source electrode SE and the drain electrode DE are formed on the substrate 10. The configuration of the switching elements SW is not limited to the aforementioned example, and the switching elements may be modified in various configurations known in the art, which can be readily embodied by those skilled in the art.

The insulating layer 15 is formed on the substrate 10 to entirely cover the scan lines GL, the data lines DL and the switching elements SW. The insulating layer 15 performs a function of removing any step difference and performing planarization. The insulating layer 15 is made of an inorganic or organic insulating material, and may have a multi-layered structure including a lower inorganic layer and an upper organic layer. The insulating layer 15 has a contact hole CNT which extends to a portion of the drain electrode DE and through which the portion of the drain electrode DE is exposed. The first electrode 20 and the drain electrode DE are electrically coupled to each other through the contact hole CNT.

The first electrode 20 is formed on the insulating layer 15. The light shielding pattern BM is also formed on the insulating layer 15. The light shielding pattern BM defines the unit pixels and has a shape surrounding the first electrode 20. The light shielding pattern BM is an area which shields the scan lines GL, the data lines DL and the switching elements SW, and allows light to be shielded, and light is shielded by the light shielding pattern BM.

The first electrode 20 is formed to entirely cover the unit pixel defined by the scan lines GL and the data lines DL. The first electrode 20 is electrically coupled to the dram electrode DE of the switching element SW provided below the first electrode 20 via the contact hole CNT through which a portion of the insulating layer 15 is opened. Here, a separate metal layer (not shown) may be interposed between the first electrode 20 and the drain electrode DE. The first electrode 20 may be made of a transparent conductive material such as ITO or IZO in order to having high electrical conductivity and high transmittance. Alternatively the first electrode 20 may be formed In a metallic mesh shape using Ag, Cu, Al or alloy thereof.

The heat generation layer 30 is formed on the first electrode 20. The heat generation layer 30 may be separated by the light shielding pattern BM defining the unit pixels. Current or voltage is applied to the first electrode 20 contacted with the heat generation layer 30, and the heat generation layer 30 is joule-heated by the applied electrical energy, thereby heating the phase change material layer 40 on the heat generation layer 30. In an embodiment, the heat generation layer 30 may be made of any one material selected from the group consisting of titanium nitride (TiN), titanium oxide nitride (TiON), titanium aluminum nitride (TiAlN), titanium silicon nitride (TiSiN), tantalum aluminum nitride (TaAlN), tantalum silicon nitride (TaSiN) and silicon germanium (SiGe). The heat generation layer 30 may be formed in a metallic mesh shape so that tight can be transmitted therethrough. However, the present embodiment is not limited thereto, and the heat generation layer 30 may have various materials, shapes and structures.

The phase change material layer 40 is formed on the heat generation layer 30. The phase change material layer 40 is made of a phase change material of which optical characteristic is changed depending on temperature. The phase change material layer 40 may be separated by the light shielding pattern BM defining the unit pixels. The phase change material layer 40 may be formed by a sputtering method.

In the phase change material layer 40, the crystallization state of the phase change material is changed depending on temperature, and the transmittance and reflexibility of the phase change material are changed depending on the crystallization state. Specifically, the phase change material becomes an amorphous state at a low temperature, and becomes a crystalline state at a high temperature. The phase change material has a response speed of a nano second or so, which is a very fast response speed. The phase change material can be driven with low power. For example, the response speed of the phase change material layer 40 is about 30 ns to 1 μs, and the driving current of the phase change material layer 40 is about 50 μA to 2 mA.

The phase change material layer 40 may be made of a chalcogenide based material which can be joule-heated by the current or voltage applied through the first electrode 20. The phase change material of this embodiment may include germanium (Ge)-antimony (Sb)-tellurium (Te). The material including Ge—Sb—Te becomes a crystalline state at a predetermined temperature or more, and becomes an amorphous state at the predetermined temperature or less. Here, the amorphous state is an opaque state in which light is not transmitted, and the crystalline state is a transparent state in which light is transmitted. Thus, if the material including Ge—Sb—Te is used, the transmittance of light can be controlled based on the temperature of the material. Generally the phase change of the material, including Ge—Sb—Te is performed at a temperature of 500 to 600° C., but the reference temperature of the phase change may be changed depending on the specific composition of the material. The phase change material including Ge—Sb—Te has the structure of a compound or alloy. For example, the compound may include Ge2Sb2Te5 as a ternary compound, (GeSn)SbTe or GeSb(SeTe) as a quaternary compound, etc.

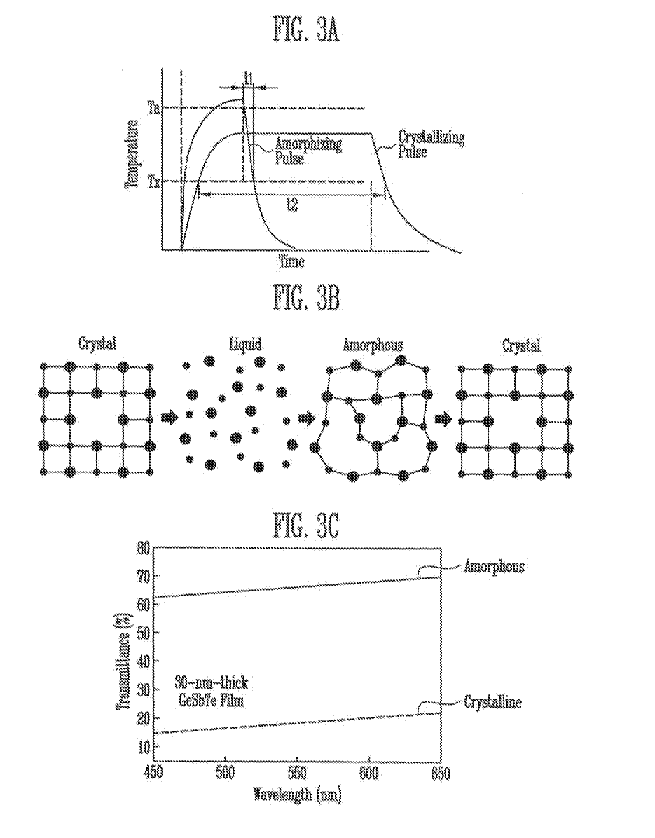

Although a material including Ge—Sb—Te has been used as the phase change material of this embodiment, the present embodiment is not limited thereto. That is, the phase change material of the present embodiment may be used without limitation as long as it is a material of which light transmittance is changed by temperature. The heat generation layer 30 and the phase change material layer 40 may be doped with at least one of carbon, nitrogen and oxygen. The optical characteristics of the phase change material will be described in conjunction with FIG. 3.

The second electrode 50 is disposed on the phase change material layer 40 to act as a common electrode. The second electrode 50 may not be defined for each unit pixel but may entirely cover a display area of the first substrate 10. The second electrode 50 may be formed of a transparent conductive material such as ITO or IZO to have high electrical conductivity and high transmittance, or may be formed in a mesh shape using Ag, Cu, Al or alloy thereof.

In an embodiment, the color filter layer CF for implementing a color may be disposed on the second electrode 50. White light radiated from the backlight unit BLU beneath the first substrate 10 is transmitted through the phase change material layer 40 acting as an optical shutter and then passes through the color filter layer CF above the phase change material layer 40. The white light passing through the color filter layer CF is radiated to the outside of the display device in a state in which the color is implemented. In addition, filters for performing functions of polarization, electromagnetic wave shielding, color correction and the like may be additionally provided in the display device.

The second substrate 60 is an upper substrate opposite to the first substrate 10. The second substrate 60 is disposed on the second electrode 50. The second substrate 60 is made of a transparent material through which light is transmitted, and substantially has the same material and structure as the first substrate 10. Therefore, its detailed description will be omitted.

FIGS. 3A, 3B and 3C are views illustrating changes in optical characteristics of a phase change material.

FIG. 3A is a graph illustrating a method of applying a pulse to the phase change material. FIG. 3B is a view illustrating transition conditions of crystalline and amorphous states of the phase change material. FIG. 3C is a graph illustrating transmittances of the crystalline and amorphous states.

If a voltage is applied to the first electrode 20, heat generation layer 30 radiates heat. If the hear generation, layer 30 radiates heat, the temperature of the phase change material layer 40 is raised to cause a phase change. Specifically, if current with an intense and short amorphizing pulse is applied to the first electrode 20 so that the phase change material of the phase change material layer 40 is heated to a melting temperature Ta or more, the phase change material is heated to the melting temperature Ta or more to become a liquid state. The amorphizing pulse requires a very short pulse for the purpose of rapid cooling. In this case, just after the phase change material is heated, the phase change material is rapidly-cooled for a short time as a first time t1 until the temperature of the phase change material reaches a crystallization temperature Tx together with the termination of the pulse, so that the state of the phase change material is changed into an amorphous state. Since the transmittance of the phase change material is high in the amorphous state, the light incident onto the phase change material layer 40 is transmitted.

Meanwhile, if current with a crystallizing pulse having weaker intensity and longer maintenance time than the amorphizing pulse is applied to the second electrode so that the phase change material is heated to a temperature between the melting temperature Ta and the crystallization temperature Tx, the rearrangement of atoms in the phase change material is performed so that the state of the phase change material is changed into a crystalline state. In this case, the crystallizing pulse is necessarily cooled while being maintained for a second time t2 in a state in which the temperature of the phase change material is the crystallization temperature Tx or more. Since the transmittance of the phase change material is low in the crystalline state, the phase change material layer 40 blocks the transmission of light incident thereonto. In such a manner, the phase change material display device can control the transmission of light.

In this embodiment, the gray scale expression of the phase change material display device is performed by the number of on/off operations of light transmission, which are performed within a predetermined time. However, the present embodiment is not limited thereto. That is, if the phase change material display device of the present embodiment uses a phase change material of which transmittance can be variably controlled according to temperature, the gray scale expression of the phase change material display device may be performed by controlling heat applied.

FIGS. 4, 5 and 6 are sectional views of phase change material display devices according to modified embodiments.

Here, components identical to those of the aforementioned embodiment are designated by like reference numerals, and their detailed descriptions will be omitted to avoid redundancy.

Referring to FIG. 4, the display device of this embodiment is a reflective phase change material display device in which a reflective layer 70 for reflecting light, in place of the backlight unit BLU of the aforementioned embodiment, is disposed beneath the first substrate 10. In this embodiment, light is controlled using a reflexibility difference caused by a phase change of the phase change material. Specifically, in a case where the phase change material layer 40 is in the crystalline state, its transmittance is low and its reflexibility is high. Therefore, the phase change material layer 40 reflects light incident thereonto. In a case where the phase change material layer 40 is in the amorphous state, its transmittance is high and its reflexibility is low. Therefore, the incident light is transmitted through the phase change material layer 40. Here, the light transmitted through the phase change material layer 40 is totally reflected due to the reflective layer 70 positioned therebelow, to be radiated to a front side of the display device. In this case, the radiated light can have a predetermined color due to the color filter layer CF disposed between the first substrate 10 and the first electrode 20.

Referring to FIG. 45, the display device of this embodiment is a transreflective phase change material display device in which a black light shielding layer BM for shielding light is disposed between the first substrate 10 and the first electrode 20. Specifically, in a case where the phase change material layer 40 is in the crystalline state, its transmittance is low and its reflexibility is high. Therefore, the phase change material layer 40 reflects light incident thereonto. In a case where the phase change material layer 40 is in the amorphous state, its transmittance is high and its reflexibility is low. Therefore, the incident light is transmitted through the phase change material layer 40. Here, the light transmitted through the phase change material layer 40 is absorbed due to the light shielding layer BM positioned therebelow, and is visualized as a black color at the outside of the display device. Thus, the phase change material display device of this embodiment can display an image expressed in black and white gray scales.

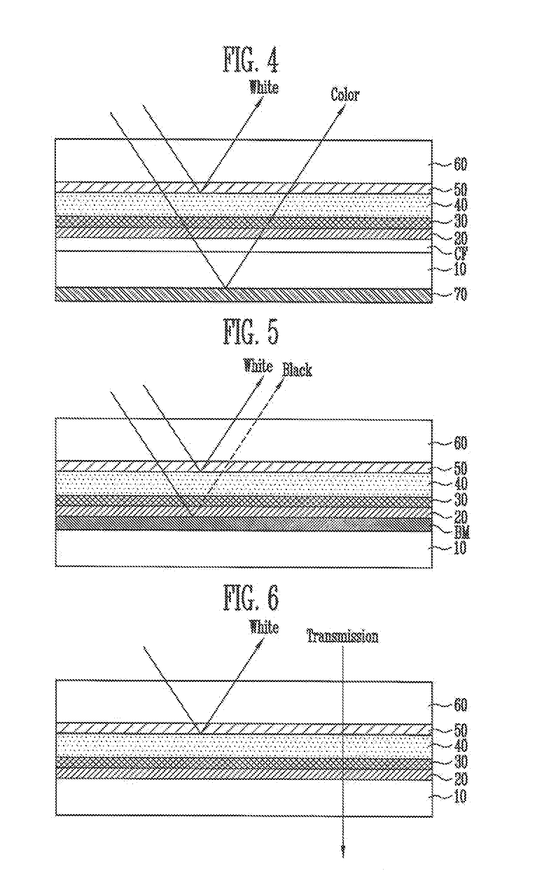

Referring to FIG. 6, the display device of this embodiment is a transparent phase change material display device which has a simpler structure without the backlight unit BLU, the reflective layer 70 and the light shielding layer BM, which are used in the aforementioned embodiments. In the transparent phase change material display device, light is controlled using only a transmittance difference. Specifically, in a case where the phase change material layer 40 is in the crystalline state, its transmittance is low and its reflexibility is high. Therefore, the phase change material layer 40 reflects light incident thereonto. In a case where the phase change material layer 40 is in the amorphous state, its transmittance is high and its reflexibility is low. Therefore, the incident light is transmitted through the phase change material layer 40. Here, the light transmitted through the phase change material layer 40 is transmitted through the entire display device and then radiated to a rear side of the display device. Thus, the phase change material display device of this embodiment can be applied as a transparent display device.

By way of summation, and review, according to the inventive concept, the phase change material display device has a phase change material layer configured with a phase change material of which optical characteristic is changed depending on temperature, thereby obtaining a simple and efficient display device structure using the phase change material as an optical shutter.

Example embodiments have been disclosed herein, and although specific terms are employed, they axe used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the inventive concept as set forth in the following claims.

What is claimed is:

1. A phase change material display device, comprising:
a first substrate;
a first electrode disposed on the first substrate;
a heat generation layer on the first electrode;
a phase change material layer on the heat generation layer, the phase change material layer being configured with a phase change material of which optical characteristic is changed depending on temperature; and
a second electrode disposed on the phase change material layer.

2. The phase change material display device of claim 1, wherein the phase change material is a chaleogenide based material.

3. The phase change material display device of claim 2, wherein the phase change material includes germanium (Ge)-antimony (Sb)-tellurium (Te).

4. The phase change material display device of claim 3, wherein the phase change material layer and the heat generation layer are doped with at least one of carbon, nitrogen and oxygen.

5. The phase change material display device of claim 1, further comprising a second substrate disposed on the second electrode,

6. The phase change material display device of claim 5, further comprising a color filter layer disposed between the second electrode and the second substrate.

7. The phase change material display device of claim 5, further comprising a backlight unit disposed beneath the first substrate configured to radiate light.

8. The phase change material display device of claim 1, further comprising a reflective layer disposed beneath the first substrate configured to reflect light.

9 The phase change material display device of claim 8, further comprising a color filter layer disposed between the first substrate and the first electrode.

10. The phase change material display device of claim 1, further comprising a light shielding layer between the first substrate and the first electrode.

11. The phase change material display device of claim 1, wherein the phase change material layer has a crystalline state of the phase change material, changed depending on the temperature, and the light transmittance and reflexibility of the phase change material layer are changed depending on the crystalline state.

12. The phase change material display device of claim 1, wherein a plurality of data lines, a plurality of scan lines intersecting the plurality of data lines, and a plurality of switching elements electrically coupled to the data lines and the scan lines are on the first substrate.

13. The phase change material display device of claim 12, wherein the first electrode is electrically coupled to one electrode of the switching element.

14. The phase change material display device of claim 12, wherein an insulating layer is on the first substrate having the switching element thereon.

15. The phase change material display device of claim 1, wherein the first electrode, the heat generation layer and the phase change material layer are separated by a light shielding pattern for defining unit pixels.
